(19) United States
(12) Patent Application Publication
(10) Pub. No.: US 2026/0084184 A1
(43) Pub. Date: Mar. 26, 2026

(54) INTEGRATED SCREENING AND AIR SEPARATION SYSTEM FOR MATERIAL PROCESSING

(71) Applicant: WEBSTER ACTION EQUIPMENT COMPANY, INC., Tiffin, OH (US)

(72) Inventors: Jay Randy Trevillian, Woodburn, OR (US); Chad Hughes, Newberg, OR (US)

(21) Appl. No.: 19/340,074

(22) Filed: Sep. 25, 2025

Related U.S. Application Data
(60) Provisional application No. 63/698,874, filed on Sep. 25, 2024.

(51) Int. Cl. B07B 4/02; B07B 1/28; B07B 4/08

(52) U.S. Cl. CPC B07B 4/02; B07B 1/28; B07B 4/08

(57) ABSTRACT

An integrated system for the efficient processing of mixed materials of varying density is disclosed. The system addresses the challenges of separating small sticky fines and conducting air classification within a confined space. The system combines a flexible mat screener with an air knife generator in a single unit, thereby reducing the need for multiple separate machines. This innovative design allows for effective screening and air separation of materials of different density while optimizing work space and reducing operational costs. The unit features a load deck, screen section, and air separation section, all integrated into one compact framework. This configuration not only enhances the processing efficiency but also minimizes the environmental impact by reducing energy consumption. The system is particularly advantageous for applications with limited available footprint, offering a streamlined solution for material processing industries.

### CROSS-REFERENCE TO RELATED APPLICATIONS

This application claims the benefit of U.S. Provisional Application No. 63/698,874, filed on Sep. 25, 2024. The entire disclosure of the above application is incorporated herein by reference.

### FIELD

The present technology relates to material processing equipment and, more particularly, to systems designed for the separation and classification of mixed materials of varying size and density.

### INTRODUCTION

This section provides background information related to the present disclosure which is not necessarily prior art.

In the field of material processing, particularly in industries dealing with mining, recycling, and waste management, the separation of mixed material streams is a significant operation. The process requires multiple machines, each designed to perform specific tasks such as screening and air classification. This multi-machine requirement not only increases the operational complexity but also escalates the costs associated with equipment purchase, maintenance, and space utilization.

The use of multiple machines to achieve mixed material separation and air classification presents several challenges. Firstly, the footprint required to accommodate multiple units may be prohibitively large, especially in facilities with limited space. This spatial inefficiency often leads to logistical challenges in material handling and flow, which may decrease the overall efficiency of the processing operation. Additionally, the energy consumption and operational costs increase with the number of machines used.

Another challenge is the integration of multiple machines into a cohesive system. Often, machines from different manufacturers are not optimized to work together, leading to suboptimal performance, increased wear and tear, and higher downtime due to maintenance needs. The complexity of coordinating multiple machines also requires skilled operators, increased spare parts inventory, and can lead to inconsistencies in the quality of the output.

Furthermore, the environmental impact of using multiple heavy-duty machines cannot be overlooked. Increased energy consumption and the need for more extensive infrastructure contribute to a larger carbon footprint. As industries move towards more sustainable practices, the need for more efficient technologies that minimize environmental impact becomes more pressing.

There is a continuing need for a more integrated approach to material processing that addresses these challenges. Desirably, a solution would consolidate the functionality of multiple machines into a single unit to reduce the footprint, energy consumption, and operational complexity of the material processing. This integration would not only enhance operational efficiency but also contribute to more sustainable industrial practices by reducing the overall environmental impact of material processing operations.

### SUMMARY

In concordance with the instant disclosure, a more integrated approach to material processing that may consolidate the functionality of multiple machines into a single unit to reduce the footprint, energy consumption, and operational complexity as well as enhance operational efficiency and contribute to more sustainable industrial practices by reducing the overall environmental impact of material processing operations, has surprisingly been discovered.

The present technology includes articles of manufacture, systems, and processes that relate to the combined functionality of screening and air classification within a single, compact unit designed to efficiently process and separate fine particulate materials.

In one embodiment, an integrated material processing system can include a load deck configured to receive a mixed material including a plurality of different density materials. A flexible mat screener can be provided in communication with the load deck, the flexible mat screener configured to receive the mixed material from the load deck and remove fine material through a a vibration. The integrated material processing system can also include an air knife generator having a blower operatively connected to a transition and a nozzle, the air knife generator configured to generate an air knife positioned to blow lower density material while allowing higher density material to fall.

In another embodiment, a method of separating materials is provided. The method may include a step of providing an integrated material processing system having a load deck configured to receive a mixed material including a plurality of different density materials; a flexible mat screener in communication with the load deck, the flexible mat screener configured to receive the mixed material from the load deck; and an air knife generator. The method may also include steps of supplying mixed material including fines, low density materials, and high density materials to the load deck, screening the mixed material with the flexible mat screener remove fines while preparing remaining material for density classification, and separating the low density materials from the high density materials using the air knife generator to blow the low density materials while allowing high density materials to fall.

In yet another embodiment, an integrated material processing system can include a load deck configured to receive mixed material including a plurality of different density materials. A first flexible mat screener can be provided in structural communication with the load deck and made of polyurethane elastomer, wherein the flexible mat screener is positioned to receive material from the load deck and configured to remove fine material through vibratory action action while preparing remaining material for subsequent processing. The integrated material processing system can also include upwardly curved lateral sides on the flexible mat screener forming a gradually curved shape having a minimum radius of curvature of at least 12 inches, wherein the upwardly curved lateral sides facilitate material flow and reduce stress on the flexible mat screener. A plurality of sieve mat sections can be arranged consecutively along a length of the flexible mat screener, wherein each sieve mat section extends transversely between sides of the flexible mat screener and is supported by first mat supports and second mat supports in operational relationship. An air knife generator can be provided. The air knife generator can include a blower operatively connected to a transition and a nozzle, and wherein the air knife generator generates a high velocity low pressure controlled air stream forming an air knife. A separation plate can be provided disposed adjacent the air knife generator and positioned to receive a lower density material ejected by the air knife from the mixed material. A second flexible mat screener can be disposed adjacent the air knife generator and beneath the separation plate to receive a higher density material from the mixed material passing through the air knife. The integrated material processing system can include a light discharge chute and a heavy discharge chute. The light discharge chute can be in communication with the separation plate, wherein the light discharge chute is positioned to receive low density materials blown by the air knife generator, and the heavy discharge chute can be in communication with the second flexible mat screener, wherein the heavy discharge chute is positioned to receive high density materials falling through the air knife. A plurality of isolators of resilient material can be mounted between a main support frame section and a movable support frame section, wherein the plurality of isolators provide controlled flexibility to the integrated material processing system. A vibration mechanism can be operatively connected to the movable support frame section to vibrate the movable support frame section to aid in separation of the mixed material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top front perspective view illustrating an integrated material processing system according to an embodiment of the present disclosure.

FIG. 2 is a bottom front perspective view of the integrated material processing system of FIG. 1.

FIG. 3 is a top rear perspective view of the integrated material processing system of FIG. 1.

FIG. 4 is a top front sectional perspective view of the integrated material processing system of FIG. 1, taken along section line 1-1.

FIG. 5 is a front sectional elevational view of the integrated material processing system of FIG. 1, taken along section line 1-1.

FIG. 6 is a flowchart illustrating a method of separating materials using the integrated material processing system shown in FIGS. 1-5, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

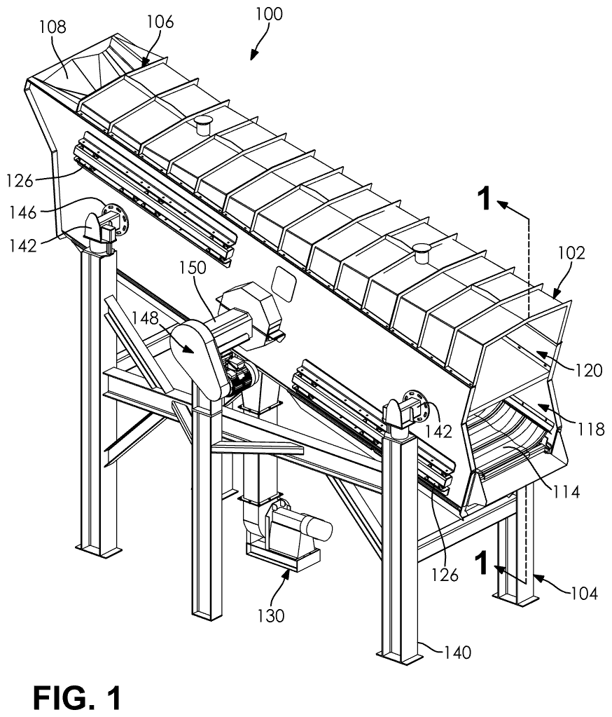

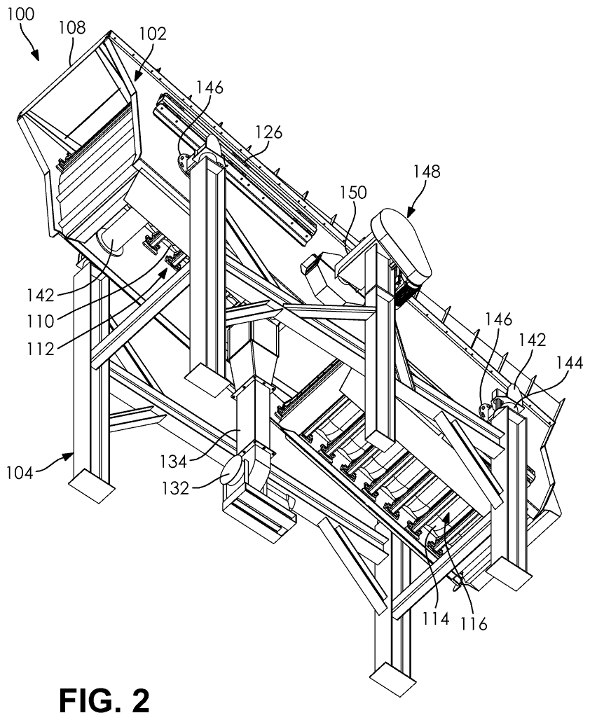

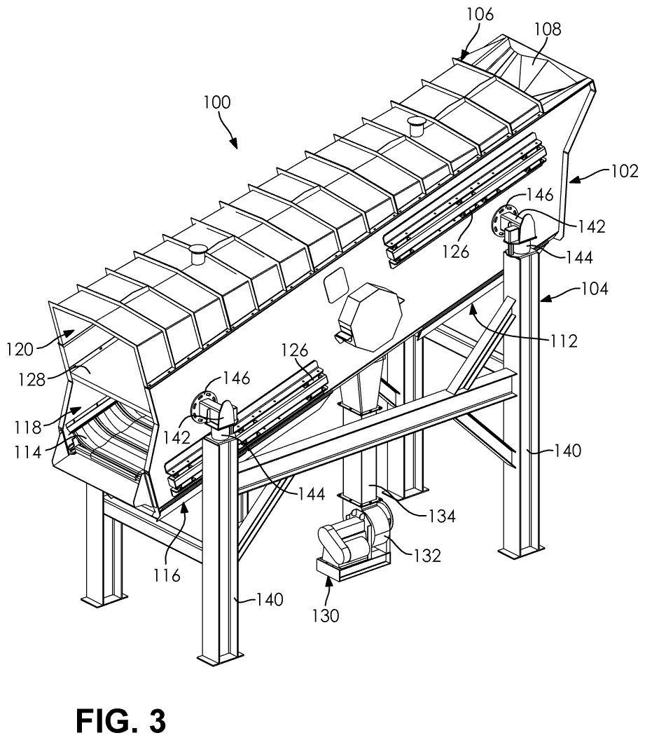

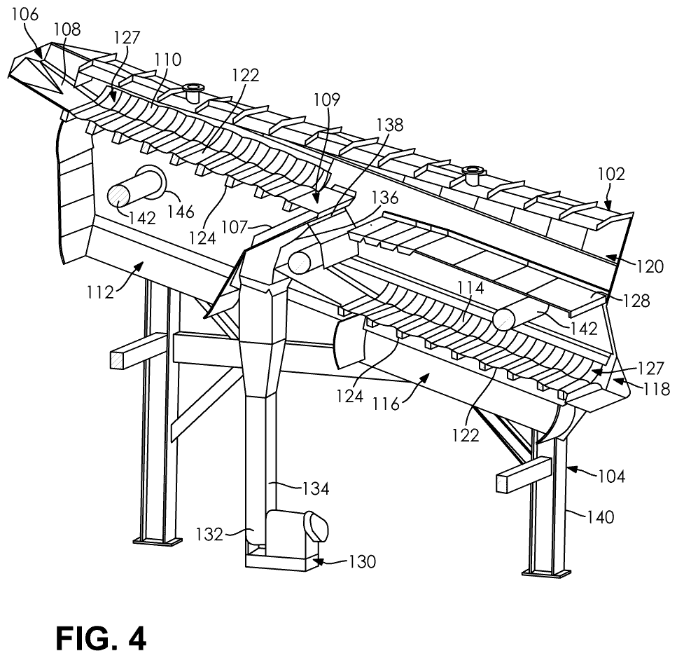

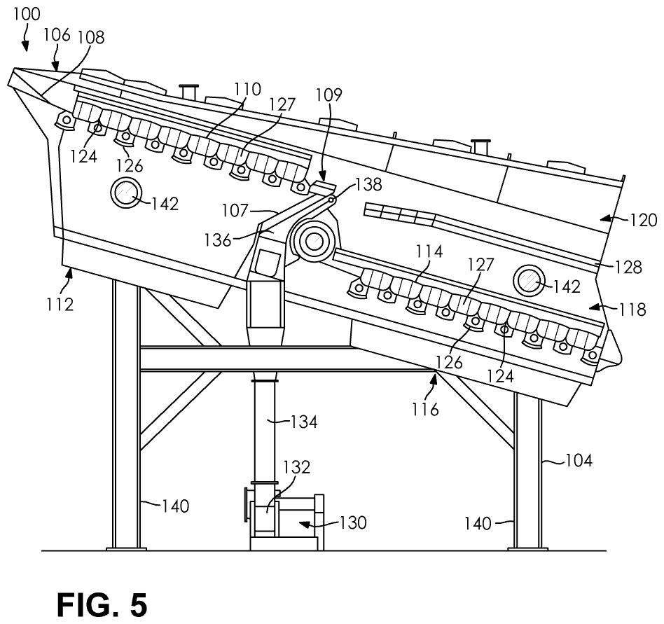

The present technology improves screening of material and air separation of particulate materials in a single compact unit. The present technology provides an integrated material processing system 100, as shown in accompanying FIGS. 1-5. Advantageously, the integrated material processing system 100 screens and separates materials of different densities and sizes in a single unit, addressing the need for processing materials with limited available footprint. The integrated material processing system 100 may be configured to be mounted on a minimal structural footprint.

The integrated material processing system 100 can include a cabinet 102 mounted to a frame 104. The cabinet 102 includes an inlet 106 for receiving the material to be sorted by the integrated material processing system 100 and a plurality of outlets for separately discharging materials sorted by the integrated material processing system 100. The cabinet 102 is movably mounted to the frame 104 and configured to vibrate and/or shake with respect to the frame 104. The vibration and/or shaking of the cabinet 102 facilitates the screening and separation of the materials of different densities and sizes deposited into the integrated material processing system 100. The cabinet 102 can be disposed at an angle within the frame 104 to position the inlet 106 above the plurality of outlets to provide a generally downward sloping path for the material to travel through cabinet 102. The downward sloping path is configured to utilize gravity to facilitate the flow of the material through the cabinet 102. Alternatively, the cabinet 102 can be positioned in a non-sloped position relative to the frame 104 where the components therein are positioned to provide a generally downward sloping path for the material to travel therethrough.

A load deck 108 can be provided adjacent the inlet 106. The load deck 108 may be configured to receive mixed material and facilitate distributing the incoming mixed material evenly across the subsequent processing sections of the integrated material processing system 100.

A first flexible mat screener 110 having a receiving end and a discharge end may be disposed within the cabinet 102 above a first discharge chute 112. The receiving end of the first flexible mat screener 110 can be positioned adjacent the load deck 108 and be configured to receive the mixed material from the load deck 108. Further, the first flexible mat screener 110 may include apertures therethrough configured to permit materials of smaller than a desired size to pass through apertures and the first discharge chute 112, thus separating the smallest size materials from the mixed material deposited in the load deck 108 and facilitating the remaining materials to travel to and exit the first flexible mat screener 110 at the discharge end thereof.

The vibration and/or shaking of the cabinet 102 facilitates the smallest size materials to pass through the apertures of the first flexible mat screener 110 and the first discharge chute 112 and conveying the remaining materials to the discharge end of the first flexible mat screener 110. It should also be understood that the apertures can be sized as desired to define the size of material that can pass through the apertures of the first flexible mat screener 110 and the first discharge chute 112. More specifically, the mixed material may include fines (small materials) and overs (larger materials) which can include both low and high density materials. The apertures in the first flexible mat screener 110 can be sized to allow the fines and/or materials having dimensions less than about ¼ inch pass therethrough. This process leaves the larger sized overs of both low and high density materials remaining and being discharged from the discharge end of the first flexible mat screener 110. It should be understood that the terms low density materials and high density materials are relative terms for different densities of materials that may be included in the mixed material where it is desired to substantially separate the low density materials and from the high density materials utilizing the integrated material processing system 100.

The first flexible mat screener 110 may also be configured to facilitate employing fluidizing effects to cause the low density materials to rise and the high density materials to settle with respect to a top surface of the first flexible mat screener 110, thus generally positioning the low density materials on top of the high density overs as the overs are discharged from the from the discharge end of the first flexible mat screener 110. In another embodiment, an optional fluidizing unit 107 may be in fluid communication with the first flexible mat screener 110 and the fluidizing unit 107 may have a fluidizing zone configured to convert the pre-screened material to a fluid-like state thereby causing the low density materials to rise and the high density materials to settle with respect to the surface of the first flexible mat screener 110.

A second flexible mat screener 114 having a receiving end and a discharge end can be disposed in the interior of the cabinet 102 above a second discharge chute 116. The second flexible mat screener 114 can be positioned lower in the cabinet 102 as compared the first flexible mat screener 110 with the receiving end of the second flexible mat screener 114 spaced apart from the discharge end of the first flexible mat screener 110. The receiving end of the second flexible mat screener 114 can be configured to receive at least a portion of the mixed material that has been screened to remove fines and discharged from the first flexible mat screener 110.

The second flexible mat screener 114 may include apertures therethrough configured to permit materials of smaller than a desired size to pass through apertures and the second discharge chute 116, thus separating the smallest size materials received from the first flexible mat screener 110 and facilitating the remaining materials to travel to and exit the second flexible mat screener 114 at the discharge end thereof and then exit the cabinet 102 through a third discharge chute or a heavy discharge chute 118. The second flexible mat screener 114 is configured to separate the mixed material received from the first flexible mat screener 110 into smaller sized material discharged through the second discharge chute 116 and larger sized material discharged through the third discharge chute 118. In other embodiments, the second flexible mat screener 114 may be substantially solid and not act to screen materials but configured to move the high density material to the discharge end of the second flexible mat screener 114 for discharge through the heavy discharge chute 118.

The vibration and/or shaking of the cabinet 102 facilitates the smaller size materials to pass through the apertures of the second flexible mat screener 114 and the second discharge chute 116 and conveying the remaining materials to the discharge end of the second flexible mat screener 114 and the third discharge chute 118. It should also be understood that the apertures in the second flexible mat screener 114 can be sized as desired to define the size of material that can pass through the second flexible mat screener 114 and the second discharge chute 116. More specifically, the mixed material received by the second flexible mat screener 114 may include fines and overs. The apertures in the second flexible mat screener 114 can be sized to allow the fines and/or materials having dimensions less than about ⅝ an inch pass therethrough to the second discharge chute 116. This process leaves the larger sized overs remaining and discharged from the discharge end of the second flexible mat screener 114 through the third discharge chute 118.

It should be appreciated that the flexible mat screeners 110, 114 may be configured in any feasible way of one of ordinary skill in the art. More specifically, the flexible mat screeners 110, 114 may also include the features described in U.S. Pat. Nos. 7,344,032/7,654,394/8,757,392, co-owned by Applicant, the entire disclosures of which are hereby are incorporated herein by reference.

The flexible mat screeners 110, 114 may further include a plurality of sieve mat sections 122 arranged consecutively along the length of the system. Each of the plurality of sieve mat sections extends transversely between the sides of the integrated material processing system 100 and is supported by a mat supports 124. Furthermore, shear blocks 126 can be provided to support and facilitate the attachment of the mat supports 124 to the cabinet 102. The flexible mat screeners 110, 114 may include upwardly curved lateral sides 127 forming a gradually curved shape. This curved shape has a minimum radius of curvature of at least 12 inches, which helps to contain and redirect material towards the center of the mat. The curved shape also reduces the amount of stress absorbed by the flexible mat screeners 110, 114 and further can increase the life of the flexible mat screeners 110, 114. The flexible mat screeners 110, 114 may also be configured to be alternately tensioned and relaxed in a flip-flow action. This action is achieved through the relative movement of the mat supports 124, causing the plurality of sieve mat sections 122 to be alternately tensioned and relaxed.

A separation plate 128 having a receiving end and a discharge end can be disposed in the interior of the cabinet 102 and form a fourth discharge chute or a light discharge chute 120 in the cabinet 102. The separation plate 128 can be positioned above and substantially parallel to the second flexible mat screener 114. The receiving end of the separation plate 128 can be spaced apart from the discharge end of the first flexible mat screener 110. The receiving end of the separation plate 128 can be configured to receive at least a portion of the mixed material discharged from the first flexible mat screener 110. More specifically, the space between the discharge end of the first flexible mat screener 110 and the receiving end of the separation plate 128 provides a gap for the mixed material discharged to enter. An air knife 138 of an air knife generator 130 may be disposed adjacent the discharge end of the first flexible mat screener 110. The air knife 138, further described herein below, can be configured to blow low density material from the mixed material discharged from the first flexible mat screener 110 across the gap onto the separation plate 128 while allowing higher density materials from the mixed material discharged from the first flexible mat screener 110 to fall through the gap onto the second flexible mat screener 114 for processing as described herein above.

The vibration and/or shaking of the cabinet 102 facilitates the lower density materials received on the separation plate 128 to be conveyed to the discharge end of the separation plate 128 and the fourth discharge chute 120. The integrated material processing system 100 provides for separating the mixed materials received by the load deck 108 into four groups; namely, small fines (first discharge chute 112), larger fines (second discharge chute 116), high density overs (third discharge chute 118), and low density overs (fourth discharge chute 120).

The air knife generator 130 can include a blower 132, an air duct 134, and a nozzle 136 in fluid communication. The air knife generator 130 may be configured to generate a flow of air from the blower 132 through the air duct 134 and nozzle 136 to form the air knife 138 to blow the low density materials from the mix of materials. The air knife 138 may also be configured to separate materials based on differences in density and bulkiness. The air knife 138 may be adjustable to control a flow and direction of air. The air knife 138 may include a high velocity low pressure controlled air stream. Advantageously, the first flexible mat screener 110 and the air knife 138 may be configured to operate as a single unit to facilitate screening, fluidization, and air separation of the low density materials and the high density materials. In certain embodiments, the optional fluidizing unit 107 can be associated with the air knife generator 130 with the blower 132 and the air duct 134 providing a flow of air the both the nozzle 136 and the optional fluidizing unit 107.

The frame 104 of the integrated material processing system 100 may further include a main support frame sections 140 having vertical beams that are stationary and a movable support frame sections 142 to which the cabinet 102 is coupled. Between these frame sections 140, 142, a plurality of isolators 144 made of resilient material may be mounted. The plurality of isolators 144 may have a plane of displacement arranged generally horizontally, providing controlled flexibility to the integrated material processing system 100. The movable support frame sections 142 can include side plates 146 that mount the cabinet 102 to the frame 104 to configure the cabinet 102 and the associated components to move relative to the stationary vertical beams. A balance may be mounted to the main support frame sections 140 with sheer blocks. Further, rubber soft mounts may absorb the motion between the movable support frame section 142 and the main support frame section 140, as well as each of the other movable members.

The flexible mat screeners 110, 114 may be disposed at a declined orientation, typically with a declination angle between about 5° and 30°. One of ordinary skill in the art may select a suitable declined orientation to configure the first flexible mat screener 110 within the scope of the present disclosure. This declined orientation aids in the movement of material through the integrated material processing system 100. Each of the flexible mat screeners 110, 114 and the air knife 138 may be configured to process moist, sticky, fibrous, or wet materials with a high percentage of the fines or near size particles. The flexible mat screeners 110, 114 may further include a dual deck configuration having a first deck and a second deck. Each of the first deck and the second deck may be configured to handle different sizes and/or densities of particulate materials.

The integrated material processing system 100 may also include a vibration mechanism 148 and a vibrator exciter 150 physically coupled to the frame 106 between the main support frame section 140 and the movable support 142 for applying a drive vibration or reciprocal force to the cabinet 102. The vibration mechanism 148 and the vibrator exciter 150 generates the vibration necessary for the operation of the integrated material processing system 100.

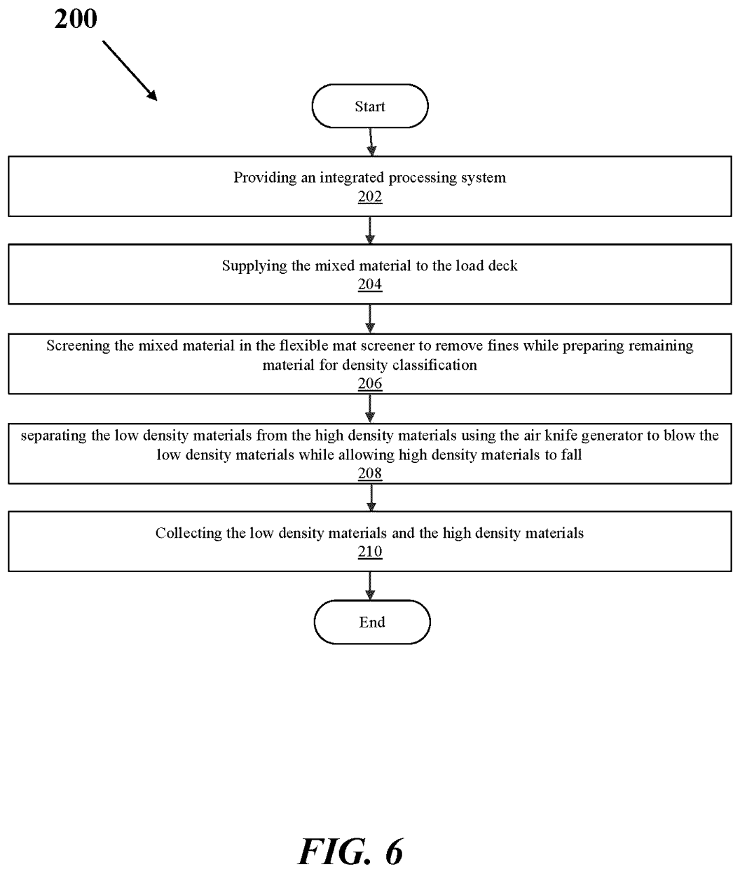

In another embodiment, a method 200 for separating materials is provided, as shown in FIG. 6. The method 200 includes a step 202 of providing the integrated material processing system 100, as described herein. The method 200 may further include a step 204 of supplying the mixed material to the first flexible mat screener 110 by loading the mixed material onto the load deck 108. The method 200 may also include a step 206 of screening the mixed material in the first flexible mat screener 110 to remove fines while preparing remaining material for density classification, which can include at least one of screening fines, de-compressing, de-clumping, fluidizing, and singulation of overs on flexible mat screeners 110, 114 to separate the fines from the mixed material. This step 206 may further include converting the mixed material to a fluid-like state in the fluidizing zone 109. The method 200 may also include step 208 of separating the low density materials from the high density materials using the air knife generator 130 to blow the low density materials while allowing high density materials to fall. Step 208 may further include supplying the low density materials and the high density materials to the air knife 138. The method 200 may include a step 210 of collecting the low density materials and the high density materials which can include, specifically by blowing the low density materials over a gap and allowing the high density materials to fall through the gap. It should be appreciated that the gap may be adjustable and the strength and shape of the air knife 138 may further be adjustable. One of ordinary skill in the art may select a suitable configuration for the gap and the air knife 138 within the scope of the present disclosure. Throughout the process, the flexible mat screeners 110, 114 and the air knife 138 can operate as a single unit, facilitating both screening and air separation of the low density particles and high density materials in a continuous and efficient manner.

Advantageously, the integrated material processing system provides an efficient solution by combining flexible mat screeners 110, 114 and an air knife 138 into a single compact unit, militating against spatial restraints, operational complexity, and increased energy consumption associated with using multiple separate machines. The integrated approach not only reduces the overall footprint of the processing operation but also enhances operational efficiency by militating against the need for complex integration of multiple machines from different manufacturers. The system may handle moist, sticky, fibrous, and wet materials with a high percentage of fines or near-size particles in a single pass and its compact design contributes to more sustainable industrial practices by reducing energy consumption and environmental impact. Furthermore, the system may process various material types and the adjustable components allow for optimized performance across different applications, thereby meeting the industry's need for a more flexible and efficient material processing solution.

### EXAMPLES

Example embodiments of the present technology are provided with reference to the several figures enclosed herewith.

### Example 1: Processing E-Waste Materials

In one implementation of the integrated material processing system 100, the system is configured to process electronic waste (e-waste) materials.

The load deck 108 receives pre-shredded material containing a mixture of fines, low density plastic fragments, and high density metal components. As the material moves through the first flexible mat screener 110, the polyurethane elastomer mats effectively remove fine particles smaller than ¼ inch. The remaining material enters the screening process, the vibratory movement of the first flexible mat screener 110 liberates fines from the overs while breaking up clumps and separating high density materials from low density materials that may be stuck together. In turn, this action causes the lighter plastic fragments to rise while the heavier metal components settle.

The air knife generator 130 then produces a high-velocity, low-pressure air jet that separates the materials based on their density. The air knife 138 is adjusted to optimize the separation of plastic film from other materials. The air knife 138 is also adjusted to optimize separation of low density materials from medium to high density materials. The separation plate 128 adjacent to the air knife generator 130 receives and guides the separated low density materials into the fourth discharge chute 120 for collection of the plastic fragments, while the second flexible mat screener 114 receives the non-low density fraction. This process allows for efficient recovery of valuable metals and recyclable plastics from e-waste, demonstrating the system's effectiveness in handling complex, mixed material streams.

### Example 2: Processing Moist Organic Waste

In another application, the integrated material processing system 100 is utilized to process moist organic waste from a composting facility.

The first flexible mat screener 110 is particularly effective in handling the sticky, fibrous nature of the organic material, preventing clogging issues common in conventional rigid deck screeners. The declined orientation of the first flexible mat screener 110, set at an angle of 15 degrees, facilitates the movement of the moist material through the system. As the organic waste passes through the fluidizing unit 107, the fluidizing zone 109 helps to break up clumps and separate materials based on density.

The air knife 138 positioned adjacent the discharge end of the first flexible mat screener 110 is then used to remove any remaining light contaminants (low density materials) such as plastic film or paper fragments from the organic matter. The system's ability to handle moist, sticky materials while providing effective separation demonstrates its versatility in processing diverse waste streams, contributing to more efficient composting operations and reducing contamination in the final compost product.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An integrated material processing system comprising:
a load deck configured to receive a mixed material including a plurality of different density materials;
a flexible mat screener in communication with the load deck, the flexible mat screener configured to receive the mixed material from the load deck and remove fine material through a vibration; and
an air knife generator including a blower operatively connected to an air duct and a nozzle, the air knife generator configured to generate an air knife positioned to blow lower density material while allowing higher density material to fall.

2. The integrated material processing system of claim 1, wherein the flexible mat screener prepares the mixed material for processing by a fluidizing unit, the fluidizing unit to facilitate sequential material flow, and the flexible mat screener, fluidizing unit, and air knife configured to operate as an integrated unit to facilitate screening and air separation of the lower density material and the higher density material.

3. The integrated material processing system of claim 1, wherein the flexible mat screener includes a plurality of sieve mat sections arranged consecutively along a length of the flexible mat screener.

4. The integrated material processing system of claim 3, wherein each sieve mat section extends transversely between sides of the flexible mat screener and is supported by a pair of first mat supports and second mat supports.

5. The integrated material processing system of claim 4, wherein a first mat support is arranged at a lowered offset position relative to an adjacent second mat support.

6. The integrated material processing system of claim 1, wherein the flexible mat screener includes an upwardly curved lateral side forming a curved shape.

7. The integrated material processing system of claim 6, wherein the curved shape has a minimum radius of curvature of at least 12 inches.

8. The integrated material processing system of claim 1, wherein the flexible mat screener is configured to be alternately tensioned and relaxed in a flip-flow action.

9. The integrated material processing system of claim 1, further comprising a separation plate disposed adjacent the air knife generator, the separation plate configured to receive the lower density material ejected by the air knife from the higher density material.

10. The integrated material processing system of claim 1, further comprising a second flexible mat screener disposed adjacent the air knife generator, the second flexible mat screener configured to receive the higher density material passing through the air knife.

11. The integrated material processing system of claim 1, wherein the air knife is configured to separate the mixed material based on differences in density.

12. The integrated material processing system of claim 2, further includes the fluidizing unit in communication with the flexible mat screener, the fluidizing unit including a fluidizing zone positioned to receive the mixed material including a lower density material and a higher density material from the flexible mat screener and separate the lower density material and the higher density material.

13. A method of separating materials comprising the steps of:
providing an integrated material processing system including:
a load deck configured to receive a mixed material including a plurality of different density materials;
a flexible mat screener in communication with the load deck, the flexible mat screener configured to receive the mixed material from the load deck; and
an air knife generator;
supplying mixed material including fines, low density materials, and high density materials to the load deck;
screening the mixed material with the flexible mat screener to remove fines while preparing remaining material for density classification; and
separating the low density materials from the high density materials using the air knife generator to blow the low density materials while allowing high density materials to fall.

14. The method of claim 13, wherein the step of separating includes generating a controlled air stream with the air knife generator.

15. The method of claim 13, wherein the steps process moist, sticky, fibrous, or wet material.

16. The method of claim 13, further comprising the step of adjusting the air knife generator to control a flow and direction of air.

17. The method of claim 13, wherein the step of screening causes the low density materials to rise and the high density materials to settle.

18. The method of claim 13, further comprising collecting separated materials by directing the high density materials to a heavy discharge chute and the low density materials to a light discharge chute.

19. The method of claim 13, wherein the step of screening includes removing fines while breaking up clumps and singulating overs material.

20. An integrated material processing system comprising:
a load deck configured to receive mixed material including a plurality of different density materials;
a first flexible mat screener in structural communication with the load deck and made of polyurethane elastomer, wherein the first flexible mat screener is positioned to receive material from the load deck and configured to remove fine material through vibratory action while preparing remaining material for subsequent processing;
upwardly curved lateral sides on the first flexible mat screener forming a gradually curved shape having a minimum radius of curvature of at least 12 inches, wherein the upwardly curved lateral sides facilitate material flow and reduce stress on the first flexible mat screener;
a plurality of sieve mat sections arranged consecutively along a length of the first flexible mat screener, wherein each sieve mat section extends transversely between sides of the first flexible mat screener and is supported by first mat supports and second mat supports in operational relationship;
an air knife generator, wherein the air knife generator includes a blower operatively connected to an air duct and a nozzle, and wherein the air knife generator generates a high velocity low pressure controlled air stream forming an air knife;
a separation plate disposed adjacent the air knife generator and positioned to receive a lower density material ejected by the air knife from the mixed material;
a second flexible mat screener disposed adjacent the air knife generator and beneath the separation plate to receive a higher density material from the mixed material passing through the air knife;
a light discharge chute in communication with the separation plate, wherein the light discharge chute is positioned to receive low density materials blown by the air knife generator;
a heavy discharge chute in communication with the second flexible mat screener, wherein the heavy discharge chute is positioned to receive high density materials falling through the air knife;
a plurality of isolators of resilient material mounted between a main support frame section and a movable support frame section, wherein the plurality of isolators provide controlled flexibility to the integrated material processing system; and
a vibration mechanism operatively connected to the movable support frame section to vibrate the movable support frame section to aid in separation of the mixed material.
